(19) United States
(12) Patent Application Publication
(10) Pub. No.: US 2017/0185056 A1
(43) Pub. Date: Jun. 29, 2017

(54) CONTROLLER HAVING LEARNING FUNCTION FOR DETECTING CAUSE OF NOISE

(71) Applicant: FANUC CORPORATION, Yamanashi (JP)

(72) Inventor: Kazuhiro SATOU, Yamanashi (JP)

(21) Appl. No.: 15/389,512

(22) Filed: Dec. 23, 2016

(30) Foreign Application Priority Data
Dec. 24, 2015 (JP) 2015-251564

(51) Int. Cl. G05B 13/02

(52) U.S. Cl. CPC G05B 13/027

(57) ABSTRACT

A controller for controlling a controlled object includes a noise detection unit for detecting electrical noise, and a learning unit. The learning unit observes a state variable including at least some of information concerning states and changes in state of an input/output signal and an internal signal of the controller, information concerning an operation state of the controlled object, and information concerning an environmental condition of the controller, and noise data associated with the electrical noise detected by the noise detection unit, and learns a cause of the electrical noise from the state variable and the noise data observed.

### BACKGROUND OF THE INVENTION

1. Field of the Invention

The present invention relates to a controller having a learning function for detecting the cause of noise.

2. Description of the Related Art

It is a common practice to control controlled objects by controllers and, for example, machine tools are controlled by numerical controllers while robots are controlled by robot controllers. One of the causes of malfunctions of such controllers is electrical noise (to be sometimes simply referred to as noise hereinafter).

Possible examples of measures to prevent malfunctions due to noise include a method for removing the cause of noise and a method for suppressing a mixture of noise. Examples of such methods include a method for electrically insulating a noise source from the surrounding environment and a method for shielding the signal path to prevent the influence of noise. For such measures, it is important to identify the cause of noise (noise source).

To identify the cause of noise by a controller for, e.g., a machine tool, a method for observing noise using a measuring device such as an oscilloscope at the installation location of the machine is generally employed. Noise is observed when internal signals, input/output signals, and the like of the controller have been changed and the operation state of the machine has been changed accordingly.

However, such noise measurement may preferably involve a field engineer for the controller, who brings measuring instruments and materials and goes to the installation location of the machine, and this is not preferable because high service costs are entailed. Further, it is often the case that noise failures followed by malfunctions intermittently occur according to the circumstances involved and it takes a long time to observe such noise.

Japanese Laid-Open Patent Publication No. 2005-159988 (patent literature 1) discloses storing information concerning the noise occurrence conditions upon noise detection in a hot water supply system which performs a hot water supply control operation. However, the technique disclosed in patent literature 1 may preferably involve a field engineer, who checks the cause of noise on the basis of the stored information.

Japanese Laid-Open Patent Publication No. 2015-50903 (patent literature 2) discloses an electromagnetic noise detector which detects an electromagnetic wave emitted by a power supply device. In the technique disclosed in patent literature 2, when electromagnetic noise equal to or higher than a threshold is detected, a field engineer may preferably collect more detailed information concerning the noise occurrence conditions and then check the cause of noise.

As described above, information concerning the noise occurrence conditions is automatically collected, but the cause of noise is not automatically identified. If the cause of noise can be automatically identified, a user of the machine other than a field engineer can take a measure against the cause of noise, and even when the field engineer takes a measure, he or she can do it immediately, thus keeping the service costs low.

It is an object of the present invention to provide a controller having a noise analysis function for automatically identifying the cause of noise.

### SUMMARY OF INVENTION

According to a first aspect of the present invention, there is provided a controller which controls a controlled object, the controller including a noise detection unit which detects electrical noise; and a learning unit which observes a state variable including at least some of information concerning states and changes in state of an input/output signal and an internal signal of the controller, information concerning an operation state of the controlled object, and information concerning an environmental condition of the controller, and noise data associated with the electrical noise detected by the noise detection unit, and learns a cause of the electrical noise from the state variable and the noise data observed.

The noise detection unit detects the amount of electrical noise occurring in the controller. The detection point is not limited to one, but a plurality of detection points may be specified. Further, the noise detection unit may be possible to provide the outside of the controller where the amount of electrical noise may influence to the controller, and generate noise data by combining the measured values of the amount of electrical noise occurring in the controller and that may influence to the controller detected from the outside of the controller. The state variable may be selected from events (matters) which may influence to generation of electrical noise, for example, states or variables of signals input to the controller from the outside of the controller (states of various operation switches, various sensors, etc.), states or variables of signals output to the outside of the controller from the controller (on/off signal of a display lamp, a control signal of coolant, a gating signal of a door, etc.), operation states of a controlled object (speed, acceleration, jerk, etc.), operation states of the controller (load status of a processor provided in the controller, using situation of wavebands of a communication unit, etc.), operation state of another controller which may close to the controller, and environment conditions (temperature, humidity, etc.) The learning unit may learn the correlation of the state variables to the noise data by using, for example, a supervised learning manner. Note that, the noise detection unit does not combine measured values of the amount of electrical noises measured at a plurality of points, but the noise detection unit may learn respective value of the amount of electrical noises measured at the plurality of points. A cause of the noise may be specified by a learning model obtained from learning results.

The learning unit may include a state observation unit which receives the state variable and the noise data; a noise source learning unit which learns a degree of influence of the state variable on the electrical noise from the state variable and the noise data; and a noise source determination unit which determines a cause of the noise from a result of learning by the noise source learning unit.

The noise source learning unit may include a label calculation unit which calculates a label value from the noise data; and a decision tree learning device which learns a decision tree for the label value using the state variable as an input vector.

Further, the noise source learning unit may include a label calculation unit which calculates a detection label value from the noise data; a neural network learning device which includes a neural network function for computing a computation label value using the state variable as input; and a function update unit which updates the neural network function so that the computation label value and the detection label value match each other, on the basis of a result of comparison between the computation label value and the detection label value.

The controller may include a communication unit which communicates data including one of an error detection code and an error correction code to detect occurrence of a communication error from the one of the error detection code and the error correction code of the communicated data, and the noise data may be configured to indicate presence of noise at time of occurrence of the communication error and indicate absence of noise during non-occurrence of the communication error.

In addition, the controller may be communicably connected to other controllers via a communication network and exchanges or shares a result of learning by the learning unit with the other controllers.

### BRIEF DESCRIPTION OF THE DRAWINGS

FIG. 1 is a block diagram illustrating the configuration of an entire machine system according to a first embodiment of the present invention;

FIG. 2 is a block diagram illustrating the schematic configuration of one machine;

FIG. 3 is a flowchart illustrating processing associated with learning in the first embodiment;

FIG. 4 is a block diagram illustrating the configuration of a noise source learning unit in a second embodiment;

FIG. 5 is a diagram illustrating an exemplary decision tree obtained in the second embodiment;

FIG. 6 is a flowchart illustrating processing associated with learning in the second embodiment;

FIG. 7 is a block diagram illustrating the configuration of a noise source learning unit in a third embodiment;

FIG. 8 is a flowchart illustrating the operation sequence of machine learning in the third embodiment;

FIG. 9 is a schematic diagram representing a model for a neuron; and

FIG. 10 is a schematic diagram representing a neural network having the weight of three layers.

### DETAILED DESCRIPTION

Below, an embodiment of a controller having a learning function for detecting the cause of noise according to the present invention will be described with reference to the accompanying drawings.

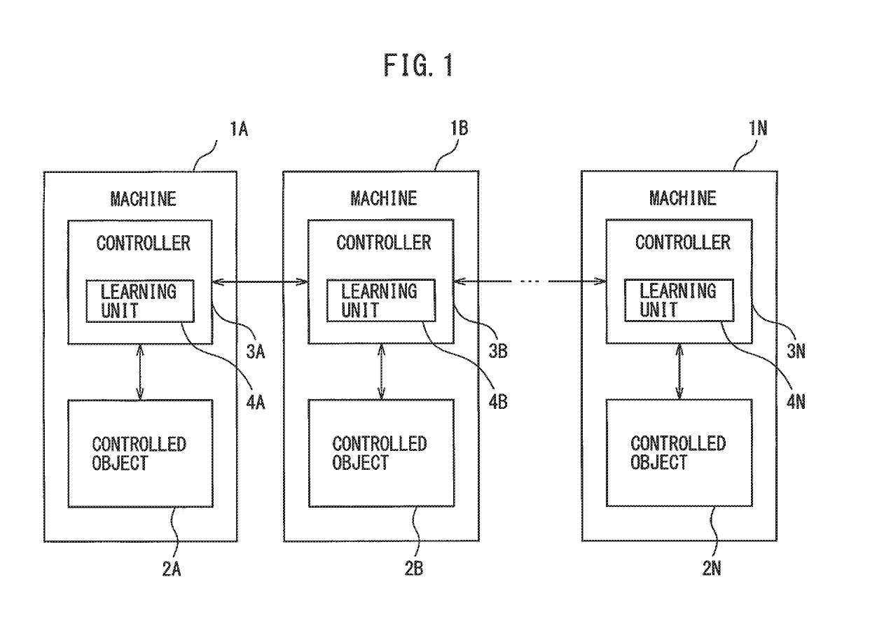

FIG. 1 is a block diagram illustrating the configuration of an entire machine system according to a first embodiment of the present invention.

The machine system according to the first embodiment includes a plurality of machines 1A, 1B, . . . , 1N. The machines may include, e.g., machine tools, forging presses, injection molding machines, industrial machines, or various robots and a plurality of such machines are arranged adjacent to each other in a factory. Although machine tools will be taken as an example herein, the machines are not limited to this example.

The machines 1A, 1B, . . . , 1N include controlled objects 2A, 2B, . . . , 2N and controllers 3A, 3B, . . . , 3N. The controlled objects 2A, 2B, . . . , 2N are processing units such as lathes, milling machines, or machining centers and are numerically controlled by the controllers 3A, 3B, . . . , 3N. The controllers 3A, 3B, . . . , 3N serve as CNC (Computer Numerical Control) devices and include learning units 4A, 4B, . . . , 4N, respectively. The controllers 3A, 3B, . . . , 3N including the learning units 4A, 4B, . . . , 4N are implemented in software or firmware on computers. The controllers 3A, 3B, . . . , 3N are communicably connected to each other via a network. The controllers 3A, 3B, . . . , 3N operate on the basis of commands from machines (or dedicated overall controllers) serving as hosts which output overall control commands. Computers or the like which implement learning units may be accessorily provided to the conventional CNC devices to implement the above-mentioned configuration, and in such a case, a set of a CNC computer and an accessory computer is collectively referred to as a controller. In either case, learning units may be implemented using various methods and such implementation is not particularly limited.

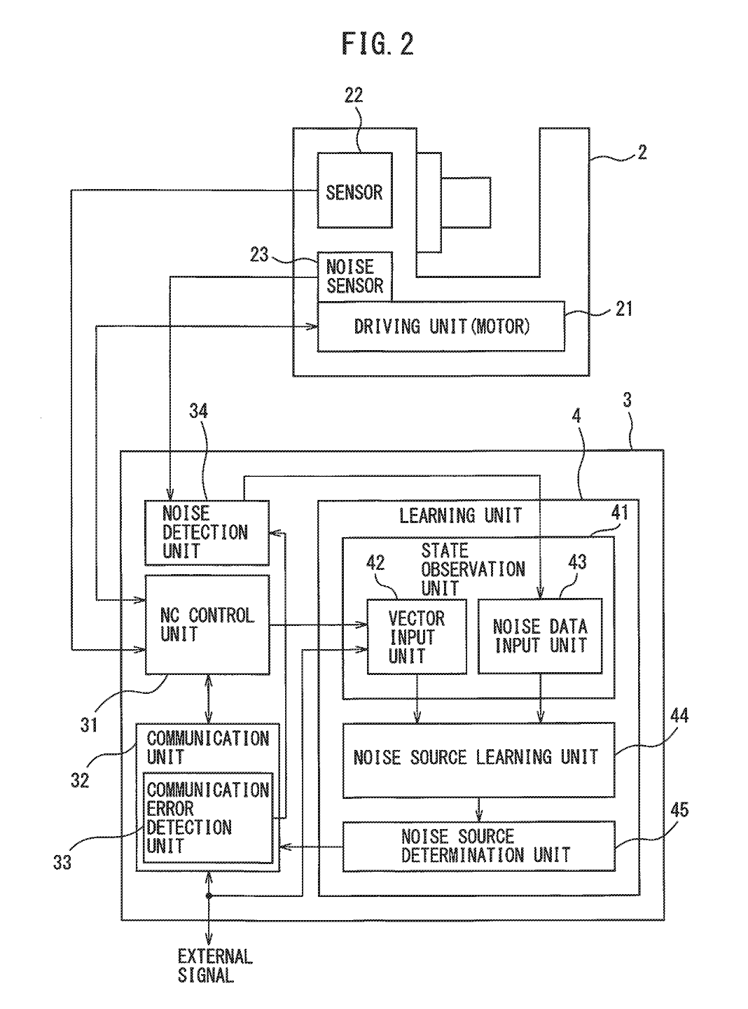

FIG. 2 is a block diagram illustrating the schematic configuration of one machine.

The machine illustrated as FIG. 2 is one of the machines 1A, 1B, . . . , 1N illustrated as FIG. 1 and its controller is communicably connected to the controllers of other machines. The machine includes a controlled object 2 and a controller 3. The controlled object 2 includes a driving unit 21 including a motor, and a sensor 22, as well as the machine part of a machine tool. The driving unit 21 includes herein a noise sensor 23, but it may not always include a noise sensor 23.

The controller 3 includes an NC control unit 31, a communication unit 32, a noise detection unit 34, and a learning unit 4. The NC control unit 31 is widely used for numerical control of a machine tool and is not particularly limited. The communication unit 32 communicates with other machine tools illustrated as FIG. 1 and the dedicated overall controller to receive operation commands for the machine tool and send data associated with, e.g., the operation state of the machine tool to other machine tools and the dedicated overall controller. The communication unit 32 includes a communication error detection unit 33 which communicates data including an error detection code or an error correction code and detects the rate of occurrence of communication errors from the received error detection code or error correction code.

The NC control unit 31 performs on the basis of the received operation commands, arithmetic processing of a current command value for the motor of the driving unit 21, preferably involved in control to move the motor to a position designated by the command value, generates and outputs a corresponding PWM signal to the driving unit 21, receives a feedback signal from the motor, and performs servo control for controlling the motor to perform desired rotation. The NC control unit 31 further receives a detection signal representing the state of the controlled object 2 detected by the sensor 22 and uses the received signal for control.

The noise detection unit 34 detects the amount of electrical noise occurring in the controller 3. For example, when the amount of electrical noise occurring in the controller 3 is equal to or larger than a predetermined value, the noise detection unit 34 sets a flag indicating the occurrence of noise to “1”; otherwise, it sets the flag to “0.” The predetermined value is determined in consideration of the amount of noise at the time of the occurrence of, e.g., a malfunction. In this case, even when the controller 3 malfunctions, the flag is set to “0” when the amount of noise is smaller than the predetermined value. This is because malfunctions may occur due to factors other than noise.

The noise detection unit 34 further receives data associated with the amount of communication error detected by the communication error detection unit 33 and the amount of electrical noise in the controlled object 2 from the noise sensor 23. When the amount of communication error detected by the communication error detection unit 33 is equal to or larger than a predetermined value, the noise detection unit 34 may set a flag indicating the occurrence of noise to “1”; otherwise, it may set the flag to “0.” In addition, when the sum of the amount of electrical noise occurring in the controller 3 and the amount of electrical noise in the controlled object 2 detected by the noise sensor 23 is equal to or larger than a predetermined value, the noise detection unit 34 may set a flag indicating the occurrence of noise to “1”; otherwise, it may set the flag to “0.”

Although only one noise detection unit 34 is provided in FIG. 2, a plurality of noise detection units 34 may be provided to set the values of a plurality of flags corresponding to the respective noise detection units, set the value of a flag on the basis of the weighted sum of the amounts of electrical noise detected by the plurality of noise detection units, or set a flag on the basis of a combination of the amounts of noise other than the above-described examples. Instead of a flag, the measure of noise may be represented at three or more levels.

The learning unit 4 includes a state observation unit 41, a noise source learning unit 44, and a noise source determination unit 45. The state observation unit 41 includes a vector input unit 42 and a noise data input unit 43. The vector input unit 42 receives observable state variables such as the state and the amount of change of a signal externally output from the controller 3, the state and the amount of change of a signal externally input to the controller 3, the operation state of the motor in the controlled object 2, the environmental state in which the controller 3 is set, and the operation states of the controllers of other machines depicted as FIG. 1. The state variables serve as vector inputs in learning. The noise data input unit 43 receives noise data detected by the noise detection unit 34. Assume herein that the noise detection unit 34 determines whether noise is high, and when noise is determined to be high, it sets a noise occurrence flag to “1”; otherwise, it sets the noise occurrence flag to “0,” as described above, and the noise data input unit 43 receives the noise occurrence flag as noise data.

The vector input unit 42 and the noise data input unit 43 receive state variables and noise data at the same point in time. For performing the learning to be described later, the number of data having a noise occurrence flag “1” is preferably close to the number of data having a flag “0”. When the frequency at which the noise occurrence flag becomes “1” is significantly different from that at which the noise occurrence flag becomes “0,” the state observation unit 41 desirably performs sampling to bring the numbers of data having noise occurrence flags “1” and “0” close to each other. For example, when the frequency of occurrence of high noise corresponding to noise occurrence flag “1” is low, data for noise occurrence flag “0” are randomly discarded; or otherwise, when the frequency of occurrence of high noise corresponding to noise occurrence flag “0” is low, data for noise occurrence flag “1” are randomly discarded; thereby performing a sampling in a manner that brings the numbers of data having noise occurrence flags “1” and “0” close to each other.

The noise source learning unit 44 learns the relationship between the noise data and the state variables from the state observation unit 41. Learning processing in the noise source learning unit 44 will be described below.

Let x be the observable input, Θ be the unobservable environmental variable, and y be the output. As described above, x is the data of, e.g., the state and the amount of change of a signal externally output from the controller 3, the state and the amount of change of a signal externally input to the controller 3, the operation state of the motor in the controlled object 2, the environmental state in which the controller 3 is set, and the operation states of the controllers of other machines depicted as FIG. 1. Θ is the unobservable environmental variable such as the distance from a device which generates noise and the conditions of location of the controller 3, such as cable forming. y is the amount of noise and takes “1” or “0” in this case.

Let fΘ(x) be the function for obtaining y from the input x and Θ. This function is called a learning model and a neural network or a decision tree, for example, is used to represent f. The noise source learning unit 44 receives a large number of sets of inputs x and noise data y and uses them to adjust the parameters of the learning model f.

In this embodiment, at least one of observable data such as the state and the amount of change of a signal externally output from the controller 3, the state and the amount of change of a signal externally input to the controller 3, the operation state of the motor in the controlled object 2, the environmental state in which the controller 3 is set, and the operation states of the controllers of other machines illustrated as FIG. 1 is defined as the input x, the amount of noise at this time is defined as the output y, the input x and the output y during the operation of the machine are observed a plurality of times to acquire a plurality of data sets, and learning is performed by a learning unit (e.g., a neural network or a decision tree). The relationship f between the input x and the output y is thus learned. At this time, in this embodiment, the represented learning model fΘ(x) varies according to the unobservable environmental variable Θ such as the conditions of location of the controller 3.

The noise source determination unit 45 identifies the cause of noise on the basis of the thus obtained learning model fΘ.

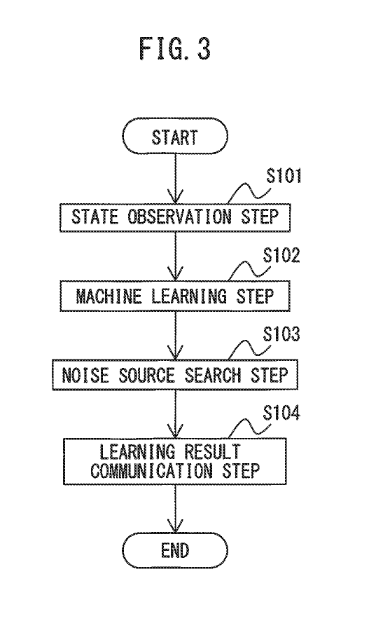

FIG. 3 is a flowchart illustrating processing associated with learning in the first embodiment.

In step S101, the state observation unit 41 observes state variables.

In step S102, the noise source learning unit 44 performs machine learning.

In step S103, the noise source determination unit 45 identifies the cause of noise on the basis of a learning model.

In step S104, the controller 3 communicates a learning model fΘ obtained by the noise source learning unit 44 and the cause of noise identified by the noise source determination unit 45, from the communication unit 32 to other controllers or the like to exchange and share learning results with each other.

Having described the machine system according to the first embodiment, an embodiment for explaining the learning unit 4 in more detail will be described next.

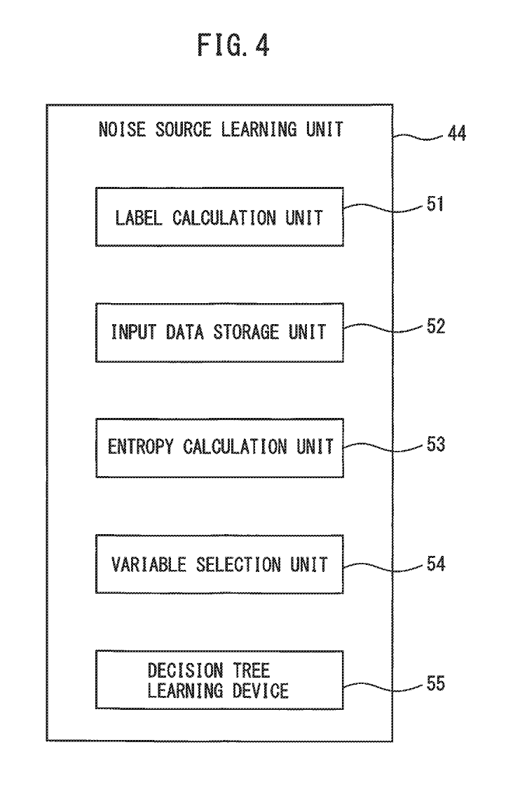

FIG. 4 is a block diagram illustrating the configuration of a noise source learning unit in a second embodiment.

A machine system according to the second embodiment has a configuration similar to that of the machine system according to the first embodiment, and in the former a noise source learning unit 44 is implemented in a decision tree learning device. The noise source learning unit 44 according to the second embodiment is implemented in, e.g., software or firmware on a computer and has a functional configuration as illustrated as FIG. 4.

The noise source learning unit 44 includes a label calculation unit 51, an input data storage unit 52, an entropy calculation unit 53, a variable selection unit 54, and a decision tree learning device 55. The label calculation unit 51 calculates a label suitable for a learning device on the basis of noise data from a noise data input unit 43 of a state observation unit 41, but it may directly use noise data as a label when the noise data represents a noise occurrence flag.

The input data storage unit 52 accumulates and stores sets of state variables (inputs x, labels) sufficient to perform decision tree learning.

The entropy calculation unit 53 calculates an entropy difference based on each variable of the input x. Since entropy calculation in decision tree learning is widely known, a detailed description thereof will not be given, and the degree of influence of each variable on the occurrence of noise can be obtained from a change in entropy (entropy difference) resulting from branching based on each variable (element).

The variable selection unit 54 selects variables used for learning, from the entropy difference based on each variable calculated by the entropy calculation unit 53. The larger the number of variables, the deeper the learning device can learn the cause of noise, but the amount of calculation dramatically increases depending on the number of variables, and it is, therefore, desired in actual learning to perform selection to exclude variables which have less influence on the occurrence of noise as much as possible.

When the number of variables of the inputs x is smaller than the arithmetic capacity of a computer for learning, the entropy calculation unit 53 and the variable selection unit 54 may be omitted.

The decision tree learning device 55 generates a decision tree which separates conditions for variables which result in the presence of noise (noise occurrence flag “1”) from conditions which result in the absence of noise (noise occurrence flag “0”), in accordance with the decision tree learning method from the sets of labels and variables of the inputs x.

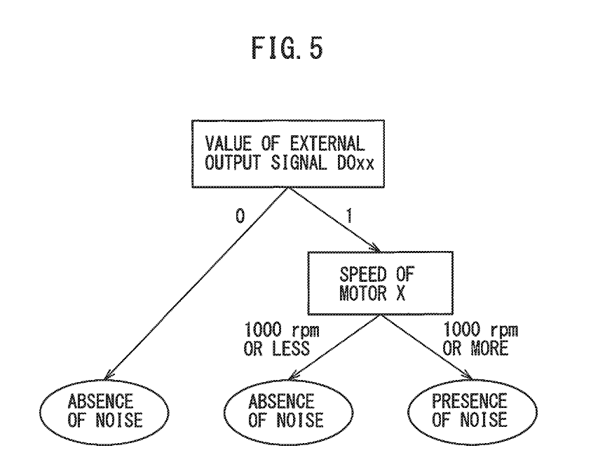

FIG. 5 is a diagram illustrating an exemplary decision tree obtained in the second embodiment.

In the decision tree, the internal nodes correspond to elements (variables) of the inputs x, and the branches to child nodes represent the conditions of values which may be taken by the elements (variables). The leaf nodes represent the predicted values of the outputs y for combinations of the values of the inputs x represented by the paths from the root node. In an exemplary decision tree illustrated as FIG. 5, since the “value of the external output signal DOxx” and the “speed of the motor X” appear at the internal nodes, it can be determined that these two conditions are related to the cause of noise. The decision tree further reveals that noise occurs when the value of DOxx is 1 and the speed of the motor X is 1,000 rpm or more.

As described above, it can be determined that the elements (variables) appearing in the decision tree are related to the cause of noise and the conditions of branches correspond to the noise occurrence conditions. Hence, a noise source determination unit 45 searches for the cause of noise on the basis of the decision tree and outputs information concerning the cause of noise.

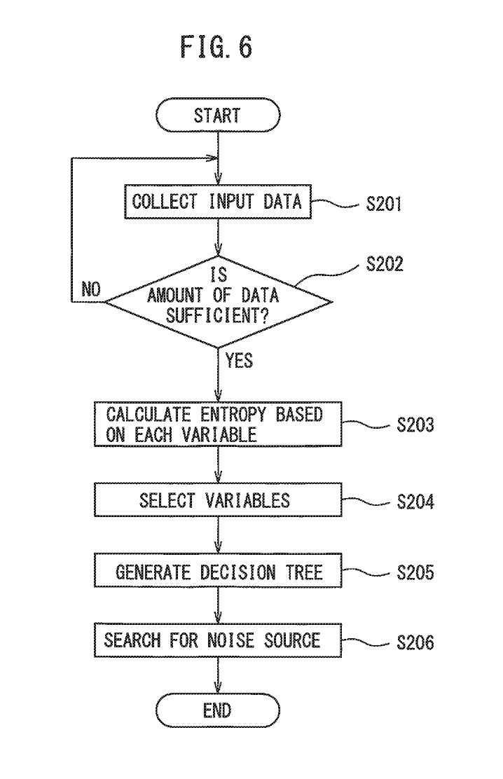

FIG. 6 is a flowchart illustrating processing associated with learning in the second embodiment.

In step S201, the state observation unit 41 observes state variables to collect input data (variables and noise data). In response to this, the label calculation unit 51 calculates labels from the noise data and the input data storage unit 52 stores the variables and the labels.

In step S202, the input data storage unit 52 determines whether the amount of data is sufficient, and when NO is determined in step S202, the process returns to step S201; otherwise, the process advances to step S203.

In step S203, the entropy calculation unit 53 calculates a change in entropy based on each variable.

In step S204, the variable selection unit 54 selects variables used for learning.

In step S205, the decision tree learning device 55 performs machine learning for generating a decision tree from the labels and the selected variables of the inputs x.

In step S206, the noise source determination unit 45 identifies the cause of noise on the basis of the decision tree.

After that, as in the first embodiment, a controller 3 communicates the cause of noise identified by the noise source determination unit 45, i.e., the learning result from a communication unit 32 to other controllers or the like.

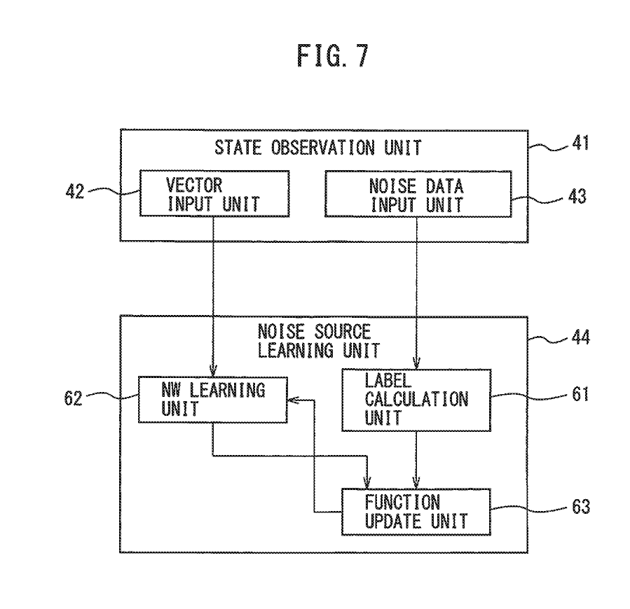

FIG. 7 is a block diagram illustrating the configuration of a noise source learning unit in a third embodiment. FIG. 7 illustrates a state observation unit, together.

A machine system according to the third embodiment has a configuration similar to that of the machine system according to the first embodiment, and in the former a noise source learning unit 44 is implemented in a “supervised” neural network learning device. The noise source learning unit 44 according to the third embodiment is implemented in, e.g., software or firmware on a computer and has a functional configuration as illustrated as FIG. 7.

A state observation unit 41 includes a vector input unit 42 and a noise data input unit 43, as in the first embodiment.

The noise source learning unit 44 includes a label calculation unit 61, a neural network (NW) learning device 62, and a function update unit 63.

The label calculation unit 61 calculates a label from the noise data output from the noise data input unit 43.

The NW learning device 62 includes a neural network (function) which has as its variables, the state variables output from the vector input unit 42, and outputs a result indicating the presence or absence of noise.

The function update unit 63 compares the label output from the label calculation unit 61 and the result output from the NW learning device 62 with each other and outputs the comparison result to the NW learning device 62.

The NW learning device 62 learns to update the neural network (function) to match the comparison results.

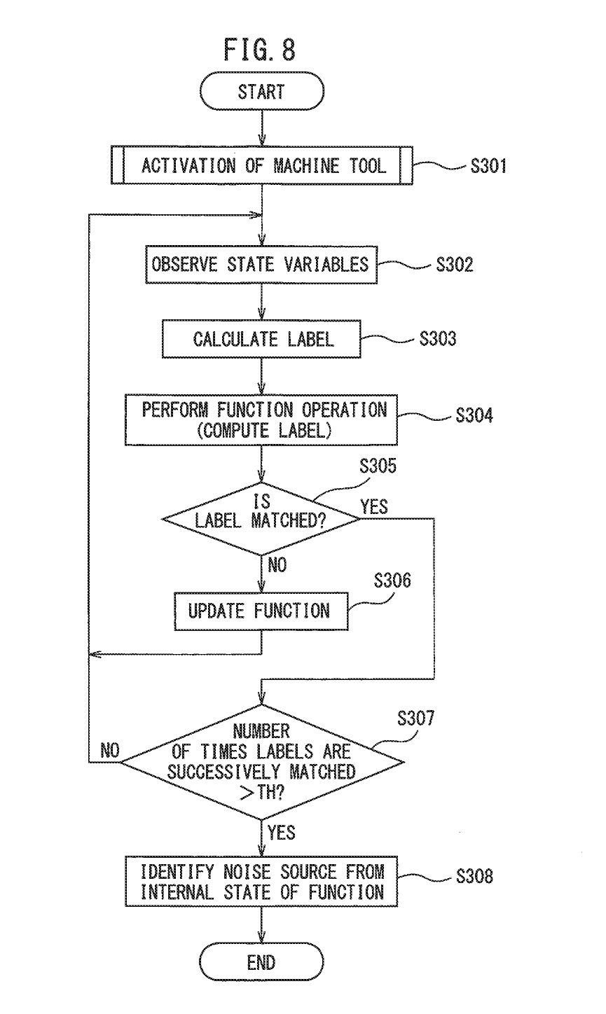

FIG. 8 is a flowchart illustrating the operation sequence of machine learning in the third embodiment.

In step S301, a machine tool is activated.

In step S302, the state observation unit 41 observes state variables and noise data.

In step S303, the label calculation unit 61 calculates a label on the basis of the noise data observed by the noise data input unit 43 of the state observation unit 41. When the noise data represents a noise occurrence flag, it is directly used as a label, as described earlier.

In step S304, the NW learning device 62 computes on the basis of the state variables observed by the vector input unit 42 of the state observation unit 41, whether noise occurs according to the state variables input at this time, and outputs the computation result. The computation result is “1” when noise occurs and is “0” when no noise occurs.

In step S305, the function update unit 63 compares whether the label output from the label calculation unit 61 and the computation result output from the NW learning device 62 match each other, and when NO is determined in step S305, the process advances to step S306; otherwise, the process advances to step S307.

In step S306, the neural network (function) is updated so that the computation result matches the label, and the process returns to step S302. Updating of the neural network (function) will be described in detail later.

In step S307, it is determined whether the number of times the computation results has successively matched the labels has exceeded a predetermined number TH, and when NO is determined in step S307, the process returns to step S302; otherwise, the process advances to step S308.

That the process advances to step S308 means that the neural network (function) has become ready to appropriately determine whether noise occurs according to the variables. In step S308, the noise source determination unit 45 searches for the cause of noise on the basis of the internal state of the neural network (function) and outputs information concerning the cause of noise.

The NW learning device 62 will be described in more detail below. The NW learning device 62 has the function of extracting, e.g., a useful rule, a knowledge representation, and a determination criterion based on analysis of a set of input data, outputting the determination results, and learning knowledge (machine learning). In this case, “supervised learning” is used as a learning algorithm and a technique called “deep learning” is further used. The NW learning device 62 is implemented by adopting, e.g., GPGPUs (General-Purpose computing on Graphics Processing Units) or large-scale PC clusters.

In “supervised learning,” a large number of sets of data of certain inputs and results (labels) are fed into the NW learning device 62, which learns features observed in these data sets and inductively acquires a model for estimating the result from the input, i.e., their relationship. When supervised learning is applied to this embodiment, it can be implemented using an algorithm for a neural network.

A learning algorithm for the NW learning device 62 will be described first.

Learning problem setting will be considered as follows:
The learning unit 4 of the controller 3 observes the environmental state to calculate the value (the presence or absence of noise) of a neural network (function).
The environment changes according to the operation.
The presence or absence of actual noise is observed for the observed environment (state variables) to obtain a label.
The neural network (function) is updated so that the computation result matches the label that is an actual result.
Learning starts in the state in which a result (the presence or absence of noise) brought about by the environment (state variables) is totally unknown or known only incompletely. In other words, the result (noise) of the operation of the machine (controller) can be obtained as data only after the machine (controller) actually operates. This means that an optimal function to search for the cause of noise can be preferably obtained by trial and error.

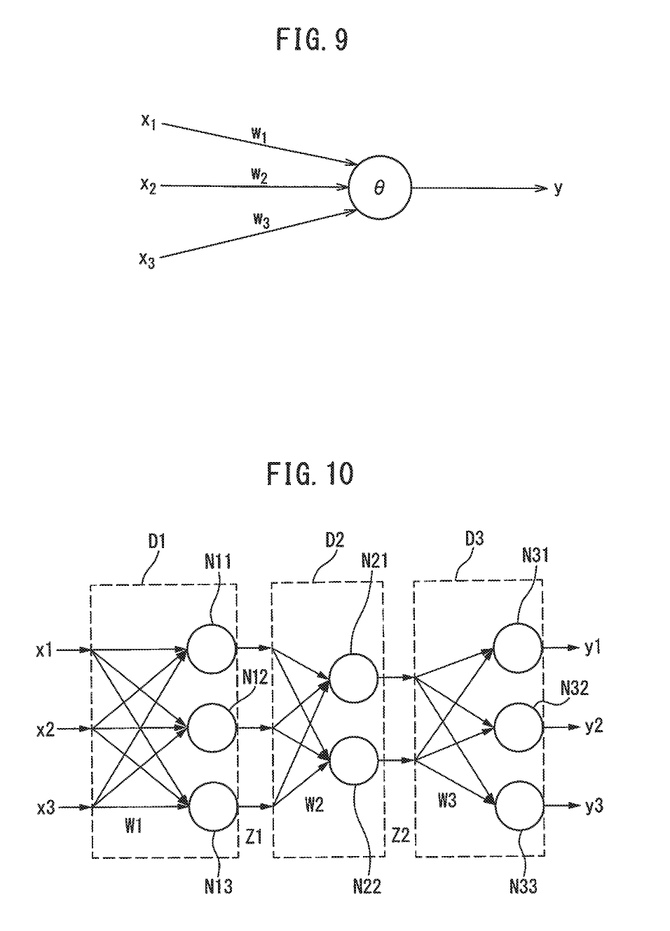

The NW learning device 62 includes a function which uses a neural network and updates the function by adjusting the parameters of the function using a technique such as the stochastic gradient descent method. The neural network is formed by, e.g., an arithmetic device for implementing a neural network imitating a model for a neuron as illustrated as, e.g., FIG. 9, and a memory. FIG. 9 is a schematic diagram representing a model for a neuron.

As illustrated as FIG. 9, the neuron serves to output an output y for a plurality of inputs x (FIG. 8 illustrates inputs x₁ to x₃ as an example). Each of the inputs x₁ to x₃ is multiplied by a weight w (w₁ to w₃) corresponding to the input x. With this operation, the neuron outputs output y given by:

y=fₖ(Σᵢ₌₁ⁿxᵢwᵢ−θ) (1)

where θ is the bias and fₖ is the activation function. Note that all of the input x, the result y, and the weight w are vectors.

A neural network having the weight of three layers and formed by combining neurons as mentioned above together will be described below with reference to FIG. 10. FIG. 10 is a schematic diagram representing a neural network having the weight of three layers D1 to D3.

A plurality of inputs x (inputs x1 to x3 are taken as an example herein) are input from the left of the neural network and results y (results y1 to y3 are taken as an example herein) are output from the right of this network, as illustrated as FIG. 10. In the third embodiment, only y1 is used as the output y.

More specifically, the inputs x1 to x3 are multiplied by a weight corresponding to each of three neurons N11 to N13 and input. The weights used to multiply these inputs are collectively denoted by W1 herein.

The neurons N11 to N13 output Z11 to Z13, respectively. Referring to FIG. 10, Z11 to Z13 are collectively referred to as feature vectors Z1 and may be regarded as vectors obtained by extracting the feature amounts of input vectors. The feature vectors Z1 are defined between the weights W1 and W2. Z11 to Z13 are multiplied by a weight corresponding to each of two neurons N21 and N22 and are then input to the neurons.

The weights used to multiply these feature vectors are collectively denoted by W2 herein.

The neurons N21 and N22 output Z21 and Z22, respectively. Referring to FIG. 10, Z21 and Z22 are collectively referred to as feature vectors Z2. The feature vectors Z2 are defined between the weights W2 and W3. The feature vectors Z21 and Z22 are multiplied by a weight corresponding to each of three neurons N31 to N33 and are then input to the neurons. The weights used to multiply these feature vectors are collectively denoted by W3 herein.

Lastly, the neurons N31 to N33 output results y1 to y3, respectively.

The operation of the neural network includes a learning mode and a search mode. For example, the weight w is learned using a learning data set in the learning mode, and the noise source determination unit 45 searches for the cause of noise in the search mode using the parameter.

Data obtained by actually activating the machine in the search mode can be immediately learned and reflected on the subsequent action (online learning), or a group of data collected in advance can be used to perform collective learning (batch learning). As another, intermediate approach, the learning mode can be interposed every time a certain amount of data is accumulated.

The weights W1 to W3 can be learned by the error backpropagation method. The information of errors enters from the right and flows to the left. The error backpropagation method is used to adjust (learn) each weight to reduce the difference between the output y when the input x is input and the true output y (teacher) (in this case, a match or mismatch of the result).

Such a neural network can have more than three layers (called deep learning). It is possible to automatically acquire from only teacher data a learning device which extracts features of the input stepwise and returns a result.

Noise data is represented using a binary flag in the first to third embodiments, but it may also be represented using ternary or higher-order multivalued data. As described earlier, a plurality of noise detection units may even be placed at different locations to respectively learn outputs from the plurality of noise detection units.

According to the present invention, the cause of noise can be automatically identified by a controller.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that various changes, substitutions, and alterations could be made hereto without departing from the spirit and scope of the invention.

What is claimed is:

1. A controller which controls a controlled object, the controller comprising:
a noise detection unit which detects electrical noise; and
a learning unit which observes a state variable comprising at least some of information concerning states and changes in state of an input/output signal and an internal signal of the controller, information concerning an operation state of the controlled object, and information concerning an environmental condition of the controller, and noise data associated with the electrical noise detected by the noise detection unit, and learns a cause of the electrical noise from the state variable and the noise data observed.

2. The controller according to claim 1, wherein the learning unit comprises:
a state observation unit which receives the state variable and the noise data;
a noise source learning unit which learns a degree of influence of the state variable on the electrical noise from the state variable and the noise data; and
a noise source determination unit which determines a cause of the noise from a result of learning by the noise source learning unit.

3. The controller according to claim 2, wherein the noise source learning unit comprises:
a label calculation unit which calculates a label value from the noise data; and
a decision tree learning device which learns a decision tree for the label value using the state variable as an input vector.

4. The controller according to claim 2, wherein the noise source learning unit comprises:
a label calculation unit which calculates a detection label value from the noise data;
a neural network learning device which comprises a neural network function for computing a computation label value using the state variable as input; and
a function update unit which updates the neural network function so that the computation label value and the detection label value match each other, on the basis of a result of comparison between the computation label value and the detection label value.

5. The controller according to claim 1, wherein
the controller comprises a communication unit which communicates data comprising one of an error detection code and an error correction code to detect occurrence of a communication error from the one of the error detection code and the error correction code of the communicated data, and
the noise data is configured to indicate presence of noise at time of occurrence of the communication error and indicate absence of noise during non-occurrence of the communication error.

6. The controller according to claim 1, wherein the controller is communicably connected to other controllers via a communication network and exchanges or shares a result of learning by the learning unit with the other controllers.
